(19) United States
(12) Patent Application Publication
(10) Pub. No.: US 2014/0012601 A1
(43) Pub. Date: Jan. 9, 2014

(54) System And Method For Furthering Online Health Verification Incorporating Medical Records

(71) Applicant: STD-Verify, Inc., Laguna Niguel, CA (US)

(72) Inventor: Patrick Gartner, Laguna Niguel, CA (US)

(21) Appl. No.: 13/937,834

(22) Filed: Jul. 9, 2013

Related U.S. Application Data
(60) Provisional application No. 61/669,173, filed on Jul. 9, 2012.

(51) Int. Cl. G06F 19/00; G06Q 50/24

(52) U.S. Cl. CPC G06F 19/3443; G06Q 50/24
USPC 705/3

(57) ABSTRACT

A computer-implemented method for providing dating services. The method can include receiving a request for verification from a first user of an online dating system, providing said first user with instructions for obtaining medical information from a health provider, receiving said medical information pertaining to said first user, publishing said medical information in a profile associated with said first user, receiving a search query from a second user, said search query identifying said profile in its results, and enabling communication between said first user and said second user.

### CROSS-REFERENCE TO RELATED APPLICATIONS

This application claims priority to U.S. Provisional Patent Application No. 61/669,173 filed Jul. 9, 2012 and entitled DATING FOR INDIVIDUALS THAT CHOOSE TO DECLARE A HEALTH STATUS RELATED TO SPECIFIC INFECTIOUS DISEASES, the entire contents of which are hereby incorporated by reference.

### BACKGROUND

The present invention relates to online health verification and, more particularly, to individuals that choose to declare his or her health status related to specific infectious diseases.

Currently, millions of people carry infectious diseases, including sexually transmitted diseases (STD), and genetic disorders. These diseases and disorders are often stigmatized and people who have them find it very difficult to find discrete ways of disclosing this information without fear of rejection. For example, when a person has an STD, they tend to hide the fact that they have the STD from potential dates because they fear that person would have a negative reaction to such news.

Furthermore, individuals who have diseases and disorders are disinclined to tell another person because they fear that the other person may further disclose that information to additional people.

There is a need for a website to assist people with and without infectious diseases and genetic disorders to disclose their medical information to other people in a discrete and verifiable manner, such as by way of medical records as provided by a medical provider. This medical information could provide some assurance as to the presence or lack of a disease or disorder within a person of interest.

### SUMMARY

According to at least one exemplary embodiment, a computer-implemented method for providing online health verification services is disclosed. The method can include receiving a request for verification from a first user of an online health verification system, providing said first user with instructions for obtaining medical information from a health provider, receiving said medical information pertaining to said first user, publishing said medical information in a profile associated with said first user, receiving a search query from a second user, said search query identifying said profile in its results, and enabling communication between said first user and said second user.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows a first part of an exemplary embodiment of a method for furthering online health verification.

FIG. 2 shows a second part of an exemplary embodiment of a method for furthering online health verification.

FIG. 3 shows a first part of another exemplary embodiment of a method for furthering online health verification.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a method for furthering online health verification through the incorporation of medical disclosures may be disclosed. The method can include a first part, the first part including a verification process, and a second part, the second part including publication and communication. The verification process may further include obtaining medical records from a health provider and verifying the identity of a user. The publication and communication part may further include the publication of the obtained medical information in either a public or a private profile and providing means by which a first user may communicate with a potential friend, mate, or health professional and give the second user access to the first user's medical information.

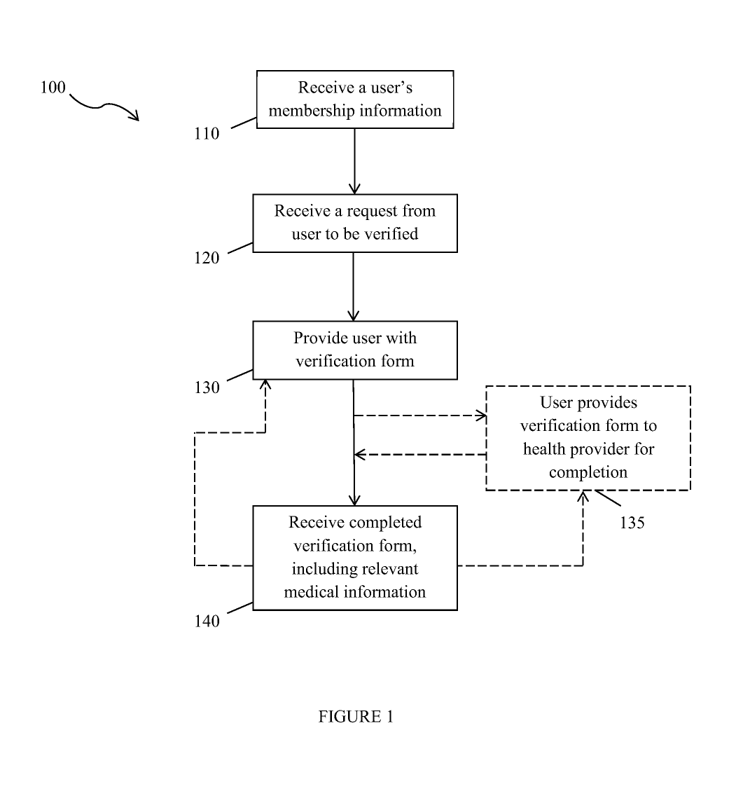

Referring to exemplary FIG. 1, a verification process 100 may be a first part of an exemplary embodiment of a method for furthering online verification of health status. At step 110, membership information may be received from a user by an online health verification system. Membership information may include the user's name, username, contact information, or other demographic information, as desired. Demographic information may further include a user's age, gender, location, or other information, as desired. Membership information may be received through an online form, or as desired. Completing step 110 may provide a user with limited access to a health verification website. For example, after completing step 110, a user may access an online health verification website or system for free, may view a health record, may search for members, but may not be able to contact members. At step 120, a request for verification may be received from a user by an online health verification system. The request for verification may be accompanied by a fee, if desired. The request for verification may indicate that a user wishes to undergo steps for disclosing his or her medical information to the online health verification system. The request for verification may further indicate that a user wishes to verify his or her identity to the online health verification system.

At step 130, a user may be provided with a verification form. The verification form may include instructions for determining the health status of the user. In some exemplary embodiments, the verification form may be a form for a health provider to fill out with information regarding the health status of the user. The verification form may request information concerning sexually transmitted diseases (STDs), other infectious diseases, genetic disorders, or other health-related information, as desired. Additionally, the verification form may request the user to prove his or her identity.

In one embodiment, a form-completion step 135 may follow step 130. A form-completion step 135 may include a user providing a health provider with the verification form for completion. The health provider may be a doctor, nurse practitioner, or other licensed provider as desired and as allowed by the relevant law. If requested by the verification form, the health provider may verify the user's identity, for example by use of a government-issued ID.

At step 140, a completed verification form may be received by a system for online health verification. The completed verification form may be received either from a user or from a health provider. The completed verification form may additionally be supplemented with copies of lab reports or medical records referring to the user, as desired. The completed verification form may be authenticated or checked by a second health provider if desired before proceeding to the next step. In one embodiment, if the second health provider determines the results are not authentic or not satisfactory, the verification form may be returned to the user or to first health provider to repeat the previous steps, as desired.

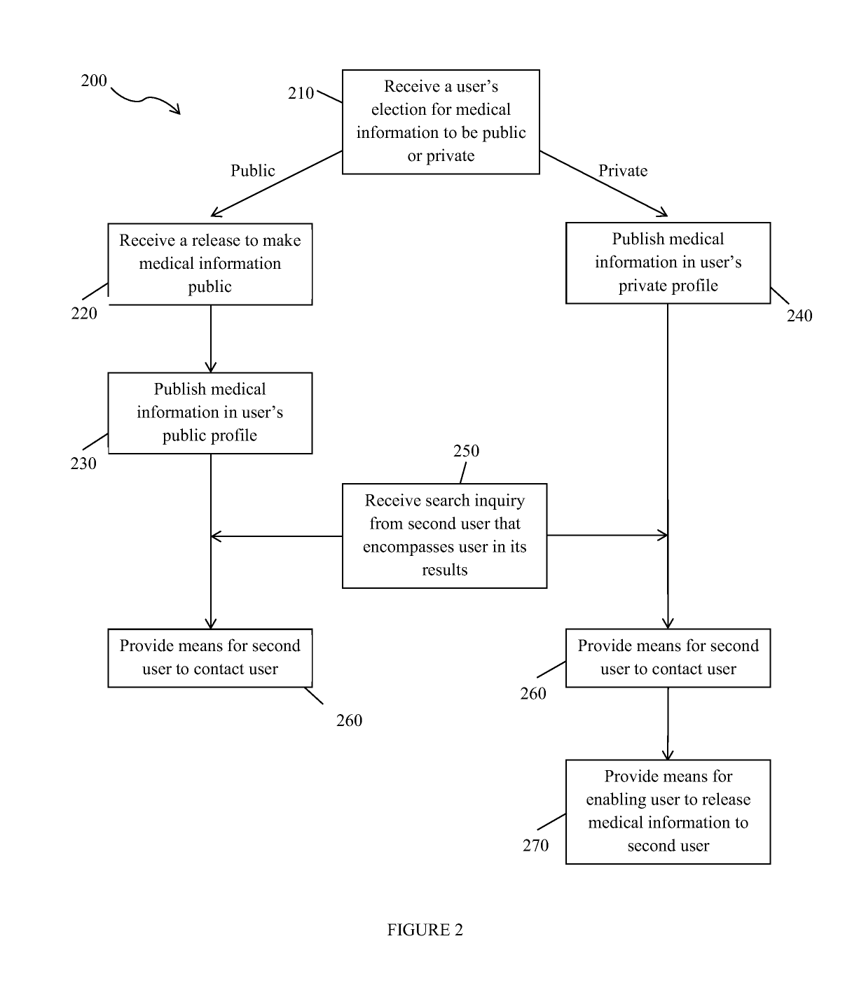

Referring to exemplary FIG. 2, publication and communication 200 may be a second part of an exemplary embodiment of a method for furthering online health verification. Publication and communication 200 may include the publication of a user's medical information on either a public or private profile and providing a means for user to communicate with potential friends, potential mates, or health professionals, and vice versa, including, where applicable, providing means for user to share private medical information with the second user.

At step 210, an election may be received from a user giving instructions to either make the user's medical information public or private. If user has indicated the desire to make the medical information public, a release may be obtained from the user at step 220. The release obtained may be worded as broadly or as narrowly as desired, and as allowed by applicable law. At step 230, a user's medical information may be published on a public profile. The public profile may be accessible by only those members of a paid-for service, or only those members who have also provided their own verified medical information, or a defined group of health professionals, or the public in general, as desired. If user has indicated the desire to make the medical information private, a user's medical information may be published on a private profile, at step 240. The private profile may not be accessed by members of the public, but may be accessed by the user, those individuals who have been granted access by the user, and the entity administering the website or service.

At step 250, a search query may be received from a potential friend, potential mate, or health professional (also referred to as a “second user”) that encompasses the user in its results. The search may be conducted upon a database of users maintained by the online health verification system. The potential friend, potential mate, or health professional may be a user of the online health verification system. The search query may be generated using keywords, demographic information, or information relating to medical status, as desired. For example, a potential mate may have searched for all males who have herpes but are not HIV+. If user is encompassed within the results of the query received, at step 260, the potential friend, potential mate, or health professional and user may be allowed to communicate with each other. For example, the user and the potential friend, potential mate, or health professional may communicate via a messaging system provided by the online health verification system, via anonymous email or via any other means, as desired.

If user has chosen to make his or her medical information public, then the potential friend, potential mate, or health professional may further view user's profile with the medical information. If user has chosen to make his or her medical information private, then the potential friend, potential mate, or health professional may view the user's profile, but may not be able to view the medical information.

If a user's medical information is private and if the user consents to release the medical information to a potential friend, potential mate, or health professional, then the medical information may be released to the potential friend, potential mate, or health professional at step 270. The release of the medical information may be achieved by sending a copy of the medical information either in hard copy or electronically, or by giving the permanent or temporary ability to view the user's private profile, or in any other manner, as desired.

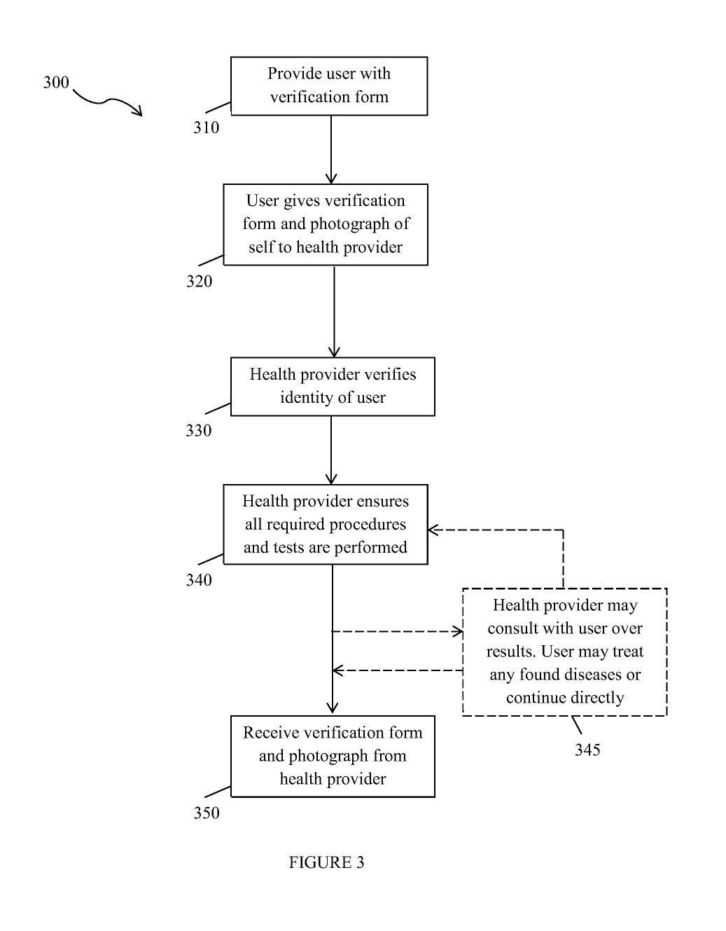

Referring now to exemplary FIG. 3, a verification process 300 may be a first part of another exemplary embodiment of a method for furthering online health verification. At step 310, a user of an online health verification website or health verification service may be provided with a verification form. The verification form may include instructions for determining the health status of the user. In another embodiment, the verification form may be a form for a health provider to fill out with information regarding the health status of the user. The verification form may request information concerning sexually transmitted diseases (STDs), other infectious diseases, genetic disorders, or other health-related information, as desired. Additionally, the verification form may request the user to prove his or her identity.

At step 320, a user may give the verification form and a self-photograph to a health provider. The health provider may be a doctor, nurse practitioner, or other licensed provider as desired and as allowed by the relevant law. The self-photograph may be, for example, a passport photo. At step 330, the health provider may verify the user's identity, for example by use of a government-issued ID. Step 330 may further include the health provider verifying that the self-photograph is of the user and not of another person.

At step 340, the health provider may ensure that all required procedures and tests are performed so that the health provider can fill out the verification form. Procedures and tests to be performed may include taking cultures, performing blood tests, or other diagnostic services, as desired.

At step 345, the health provider may consult with the user concerning the results of the procedures and tests performed at step 340. If the results are undesirable to the user, for example because the results show the existence of a disease or condition, user may undergo treatment before step 340 is repeated. Step 340 and consultation step 345 may be repeated until the results are desirable to the user.

At step 350, a completed verification form may be received. The completed verification form may be received either from the user or from a health provider. The completed verification form may additionally be supplemented with copies of lab reports or medical records referring to the user, as desired. The completed verification form may further be supplemented by the self-photograph as provided by the user to the health provider. The completed verification form may be authenticated or checked by a second health provider if desired. Subsequently, the second portion of the method may be performed, substantially as described in FIG. 2.

In another embodiment, as a non-limiting example, the invention may be integrated into an online dating service. An online dating service with a health verification system may allow users to disclose their medical information as desired to potential mates either on their dating profile or as a separate profile as part of the service. An online dating service with a health verification system may further allow users to search for potential mates using criteria based on what infectious diseases or genetic disorders other users of the system may or may not have. This integration of online dating and an online health verification system may therefore allow users to efficiently and effectively direct their search for potential mates based on these criteria.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for providing health verification, comprising:
receiving a request for verification from a first user of an online health verification system;
providing said first user with instructions for obtaining medical information from a health provider;
receiving said medical information pertaining to said first user;
publishing said medical information in a profile associated with said first user;
receiving a search query from a second user, said search query identifying said profile in its results; and
enabling communication between said first user and said second user.

2. The method of claim 1, wherein said online health verification system is integrated with an online dating service.

3. The method of claim 1, further comprising receiving said first user's membership information.

4. The method of claim 3, wherein said membership information includes at least one of a name, a username, demographic information, and contact information.

5. The method of claim 1, wherein said profile further allows said medical information to be displayed to a second user.

6. The method of claim 5, further comprising allowing said first user to determine whether said medical information is visible by members of the public or whether said medical information is visible only to one or more of a second user chosen by the first user.

7. The method of claim 1, further comprising:
conducting tests to determine whether said first user has a medical condition; and
having said first user and said health provider consult as to a meaning of results of said tests.

8. The method of claim 7, further comprising conducting a treatment regimen to correct the medical condition.

9. The method of claim 7, wherein said medical condition is one of a sexually transmitted disease, an infectious disease, or a genetic disorder.

10. The method of claim 1, further comprising the verification, by a third party, of the identity of said first user.

11. The method of claim 10, wherein the verification includes verifying via a government-issued identification.

12. The method of claim 10, wherein said third party is a health provider.

13. The method of claim 10, further comprising:
having said first user provide a matching photograph of said first user to said third party; and
receiving said matching photograph from said third party.

14. The method of claim 1, further comprising authenticating said received medical information pertaining to said first user prior to publishing in a profile.

15. The method of claim 14 wherein said authentication is performed by a health provider.

16. A system for providing health verification and communication services, comprising:
a server computer hosting an online health verification system;
a first visitor computer communicatively coupled to the server computer over a network, said computer being used by a first user of the online health verification system; and
a second visitor computer communicatively coupled to the server computer over a network, said second computer being used by a second user of the online health verification system;
wherein a verified medical information report is received by the server computer, said verified medical information report comprising medical information pertaining to said first user; and
wherein said medical information is accessible by said second visitor computer only based upon a request from said first user.

17. The system of claim 16, wherein said online health verification system is integrated with an online dating service.

18. The system of claim 16, wherein said verified medical information report is sent by a health provider.

19. The system of claim 16, wherein said verified medical information report further comprises a photograph of said first user.

20. The system of claim 16, further comprising means for said second user to communicate anonymously with said first user.

21. A method for facilitating online health verification, comprising:
instructing a health provider to verify the identity and medical records of a first user of an online health verification system;
receiving from said health provider medical information pertaining to said first user;
granting access to said medical information to a second user, upon a request from said first user that said medical information be provided to the second user; and
providing means for said second user to communicate with said first user.
